(19) United States
(12) Patent Application Publication
(10) Pub. No.: US 2025/0269412 A1
(43) Pub. Date: Aug. 28, 2025

(54) COSMETOLOGY EQUIPMENT CLEANING DEVICE

(71) Applicant: Lynne G. Benn, Virginia Beach, VA (US)

(72) Inventor: Lynne G. Benn, Virginia Beach, VA (US)

(21) Appl. No.: 18/588,216

(22) Filed: Feb. 27, 2024

(51) Int. Cl. B08B 9/20

(52) U.S. Cl. CPC B08B 9/20; B08B 2209/08

(57) ABSTRACT

A washing device for cleaning cosmetology equipment and accessories may be provided. The washing device includes a washer body, a washer door, an upper wash rack and a lower wash rack wherein the upper wash rack and lower wash rack have a grid structure which may be configured to hold various cosmetology equipment and accessories.

### FIELD OF THE DISCLOSURE

The present disclosure relates generally to a cleaning or washing device for cleaning cosmetology equipment.

### BACKGROUND

Cosmetology is a regulated industry, which requires certain standards of cleanliness for its tools, equipment, and facilities. These tools and facilities are required to be clean and sanitary in order to protect the public health. Some equipment commonly used in salons, beauty parlors, or barber shops is awkward to handle and difficult to clean. For example, cylindrical hair curlers with open interiors are commonly washed, sanitized, and dried manually.

Thus, currently, beauticians, hair stylists, hairdressers, and barbers have to deal with the challenge that many tools, equipment, or accessories must be washed, sanitized, and dried manually. Some accessories may be washed in sinks or bowls, while other contact items such as combs and scissors are washed and then placed in a separate glass container filled with a sanitizing liquid.

This manual approach is labor intensive, slow, wasteful of water, and restricts the availability of the equipment. Cosmetologists are thus required to provide sufficient personnel and excess equipment to be available to serve the busy or high load times, increasing the costs of operation.

Manually washing and sanitizing tools, accessories and equipment is tedious and time consuming for the employee. Typically, the beauty or barber shop will hire a person who is responsible for cleaning all the tools, accessories, and equipment, as well as shampooing the clients. The manual washer must allocate a slow business time to wash and sanitize the tools, accessories, and equipment. This task takes personnel away from serving clients. Often, the wash station is remote or distant from the client workstation. The washer may have to go back to a washing bowl (which often is located in the back of the salon or shop) to hand clean, sanitize, and dry the tools, accessories, and equipment. The responsibility to manually wash and sanitize tools, accessories, and equipment is a tedious and time-consuming task.

An automated cleaning device would reduce the need for personnel and equipment, improving the profitability of salons, beauty parlors, or barber shops; employees would be free to dedicate more time to serving clients. Employees would be relieved of a tedious task, while automation could save energy and water.

### SUMMARY

To this end, the present disclosure provides a washing device that automates the cleaning of a wide variety of cosmetology equipment and accessories. The washing device may include a washer body, a washer door, an upper rack and a lower rack, both configured to receive a wide variety of the cosmetology equipment and accessories.

Washer racks maybe based on a flat wire grid or screen. The washer racks may thus be inserted into the washer and the rack may be sized so as to insert securely in the washer body. Storage units may be constructed of suitable materials, such as plastic or metal.

These and other aspects will become apparent to those skilled in the art after a reading of the following description when considered with the drawings.

### BRIEF DESCRIPTION OF THE DRAWINGS

Illustrative embodiments of the present disclosure are described in detailed below with reference to the attached drawing figures and wherein:

FIG. 1 illustrates a perspective view of an example of a washing device for cleaning cosmetology equipment, according to an embodiment of the disclosure;

FIG. 2 illustrates a perspective view of the washing device shown in FIG. 1 with the front door open and showing a first configuration of washer racks, according to an embodiment of the disclosure;

FIG. 3 illustrates a perspective view of the washing device shown in FIG. 1 with the front door open and showing a second configuration of washer racks, according to an embodiment of the disclosure;

FIG. 4. illustrates a plan view of a first example of the washer rack for holding cosmetology equipment, according to an embodiment of the disclosure;

FIG. 5 illustrates a plan view of a second example of the washer rack for holding cosmetology equipment, according to an embodiment of the disclosure;

FIGS. 6A and 6B illustrate front view of a portion of the washing device shown in FIG. 1 and example methods of installing the washer rack therein, according to an embodiment of the disclosure;

FIG. 7 through FIG. 11 show examples of various attachments and/or features of the washer rack for holding cosmetology equipment, according to an embodiment of the disclosure;

FIG. 12 illustrates a perspective view of an example a washer rack storage cabinet, according to an embodiment of disclosure.

### DETAILED DESCRIPTION

Several embodiments will be described more fully in reference to the accompanying figures. However, this disclosure should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

The terminology used herein is for the purpose of describing particular embodiments only and is not intended to be limiting of the invention. As used herein, the singular forms “a,” “an,” and “the” are intended to include the plural forms as well, unless the context clearly indicates otherwise.

It will be understood that when an element is referred to as being “attached,” “coupled” or “connected” to another element, it can be directly attached, coupled or connected to the other element or intervening elements may also be present. In contrast, when an element is referred to as being “directly attached,” directly coupled” or “directly connected” to another element, there are no intervening elements present.

All patents, patent applications and publications referred to herein are incorporated by reference in their entirety. In case of a conflict in terminology, the present specification is controlling.

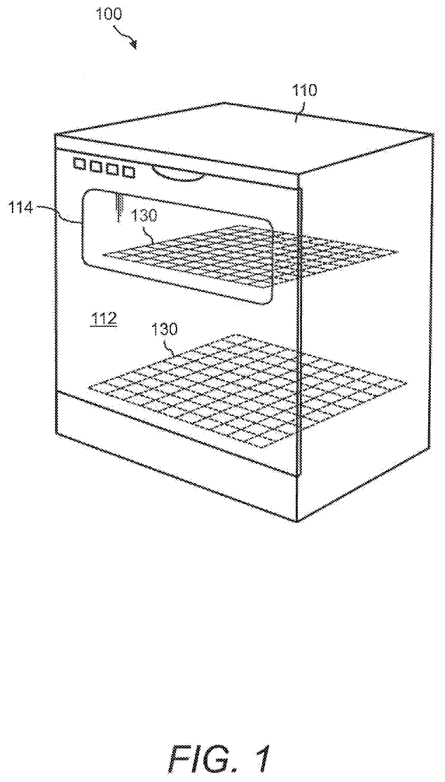

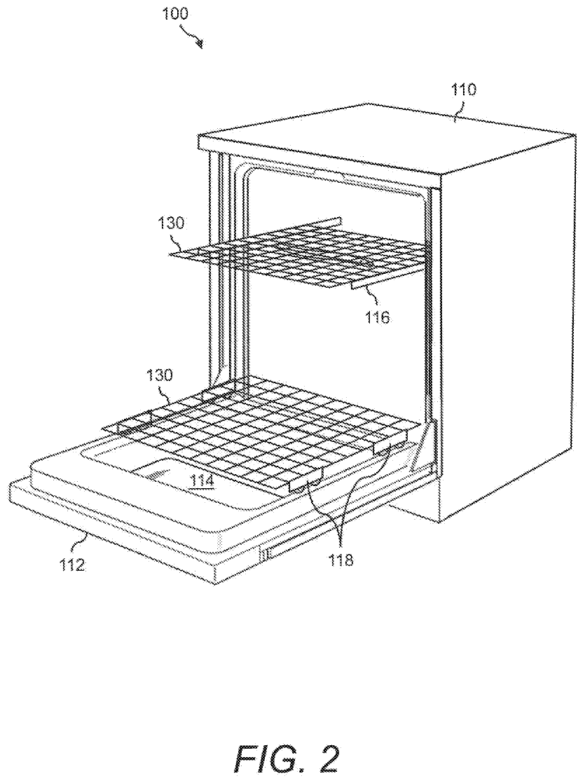

The present invention provides a washing device that automates the cleaning of cosmetology equipment and accessories. As shown in FIG. 1, the washing device 100 includes a washer body 110, a washer door 112, an optional window 114, an upper wash rack 130 and lower wash rack 131. The body 110 and washer racks 130, 131 may be individualized (e.g., color, name, tags, etc.) in that a salon may have multiple devices for multiple users. Referring to FIG. 2, the upper wash rack 130 may be positioned on pullout slide bars 116 for ease of moving from a washing position in the washer body 110 to an extended position as shown outside of the washer body 110 for loading. The lower wash rack 131 may include roller hardware 118 for moving the lower wash rack 131 to an extended position as shown for loading.

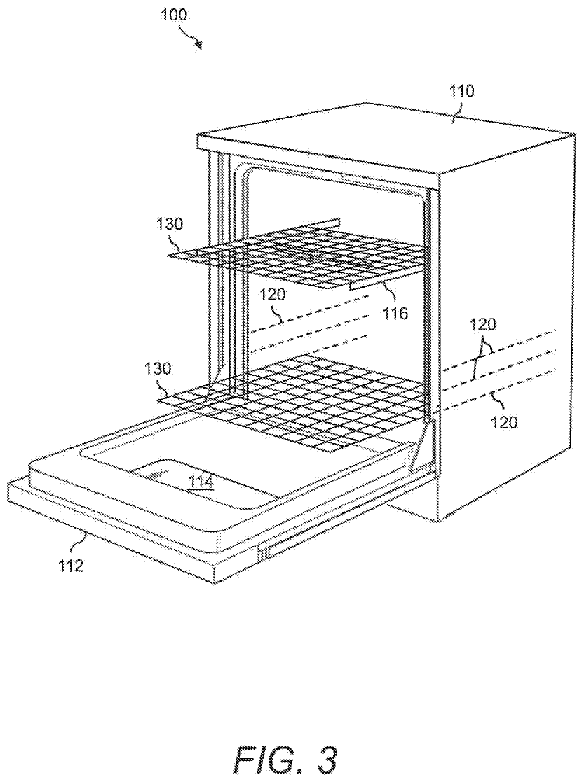

Referring to FIG. 3, the washer body 110 may include inner sidewall mounts 120 for allowing the upper wash rack 130 to be repositioned to accommodate multiple shapes of equipment or accessories. Multiple racks 130 may be positioned in the device 100.

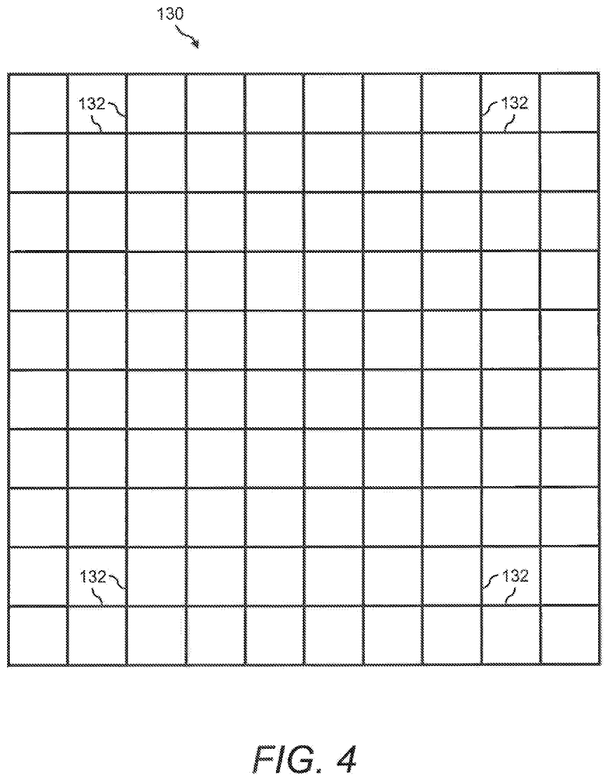

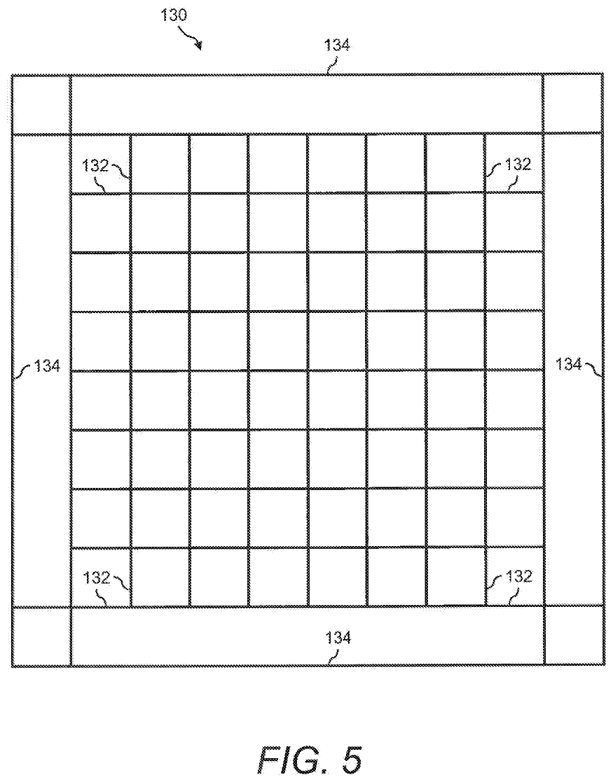

FIGS. 4 and 5 illustrate embodiments of the upper wash rack 130 having a grid structure 132 which may include a grab bar 134. The lower wash rack 131 may have a similar grid configuration. The racks 130, 131 may be metal, metal-coated or plastic. The racks 130, 131 are configured to hold various cosmetology equipment and accessories.

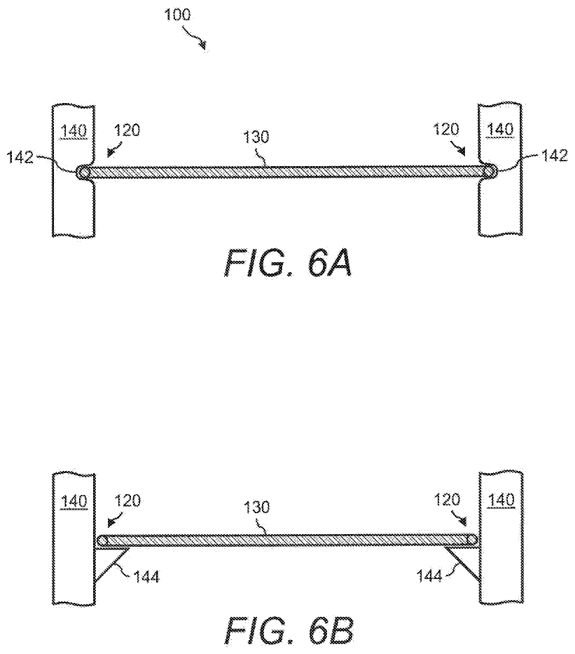

FIGS. 6A and 6B illustrate the inner sidewall mounts 120 including a body inner sidewall 140. FIG. 6A shows an inner sidewall 140 with a channel or groove 142. FIG. 6B shows an inner sidewall 140 with a side rail 144.

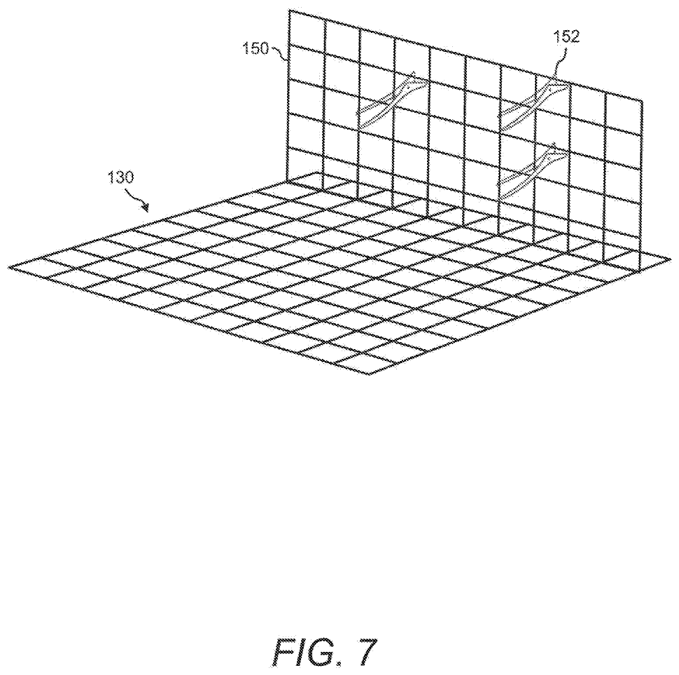

FIG. 7 shows an alternative embodiment in which the upper wash rack 130 includes a vertical rack attachment 150 configured to hold clips, for example, hair clips 152.

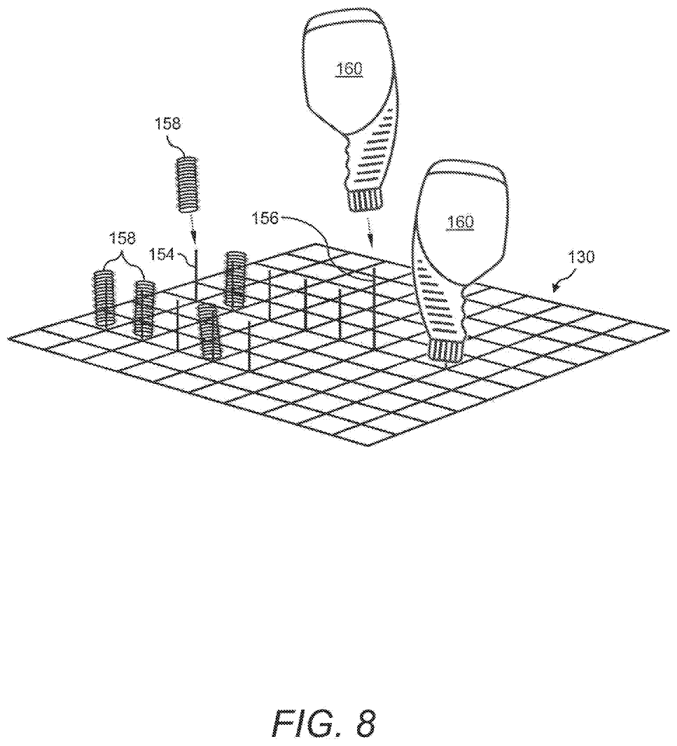

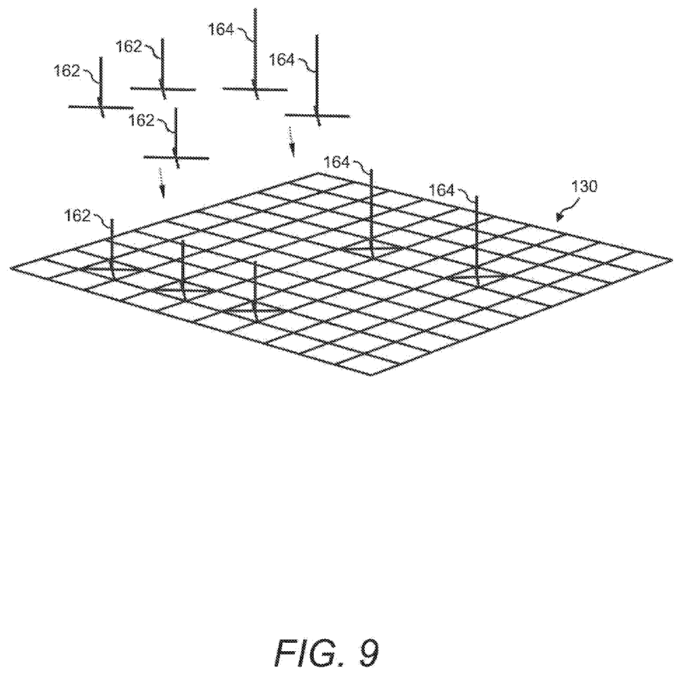

FIG. 8 shows an alternative embodiment in which the upper wash rack 130 includes short pegs 154 and long pegs 155 configured to hold accessories, having a hollow portion, for example curlers 158 on the short pegs 154 and spray bottles 160 on the long pegs 155. As shown in FIG. 9, the short pegs 162 and long pegs 164 may have a removable or detachable configuration.

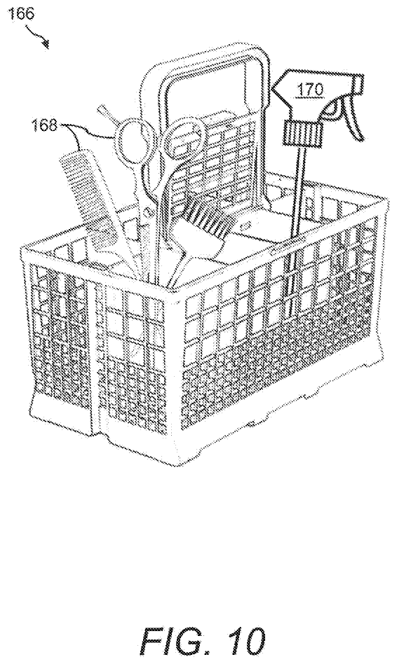

FIG. 10 illustrates a basket 166 which may be positioned on or in the lower wash rack 131, configured for washing oddly shaped articles such as cosmetology tools 168 and spray bottle heads 170.

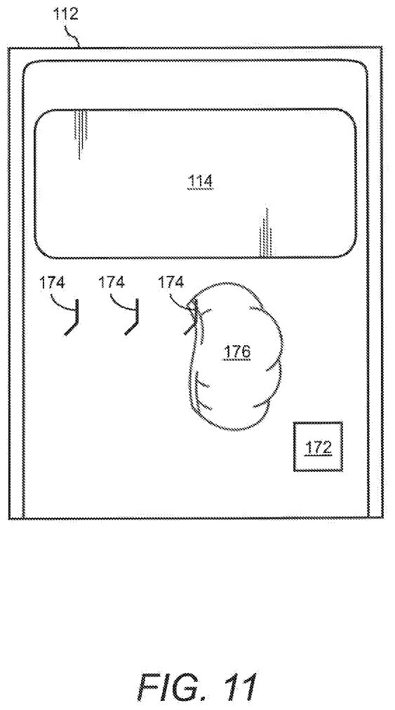

FIG. 11 illustrates an arrangement of hooks 174 on the inside washer door 112 for holding plastic caps 176 and the like. A sanitary soap dispenser 172 may also be included.

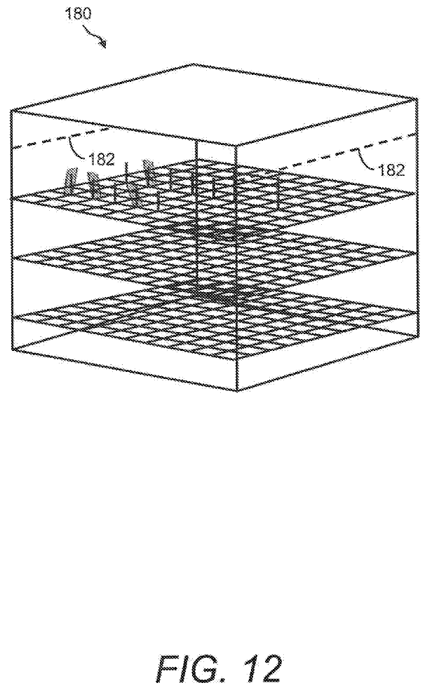

FIG. 12 shows the embodiment in which multiple racks 130 may be mounted.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim, accordingly, including the right to be able to amend any originally filed claim to depend from and/or incorporate any feature of any other claim although not originally claimed in that manner. These and other objects and/or aspects of the present invention are explained in detail in the specification set forth below.

It will be understood that certain features and sub combinations are of utility and may be employed without reference to other features and sub combinations and are contemplated within the scope of the claims.

That which is claim is:

1. A washing device for cleaning cosmetology equipment and accessories, the washing device comprising a washer body, a washer door, an upper wash rack and a lower wash rack wherein the upper wash rack and lower wash rack have a grid structure which is configured to hold various cosmetology equipment and accessories.

2. The washing device according to claim 1, wherein the upper wash rack includes a vertical rack attachment for holding clips.

3. The washing device according to claim 1, wherein the upper wash rack includes short pegs and long pegs configured to hold accessories having a hollow portion.

4. The washing device according to claim 3, wherein the short pegs and long pegs have a detachable configuration.

5. The washing device according to claim 1, further including a basket configured to hold oddly shaped accessories.

6. The washing device according to claim 1, wherein the washer body includes inner sidewall mounts for allowing repositioning of the upper wash rack.
